(19) United States
(12) Patent Application Publication
(10) Pub. No.: US 2023/0112290 A1
(43) Pub. Date: Apr. 13, 2023

(54) SYSTEM AND METHOD FOR FACILITATING A TRANSPORTING PROCESS

(71) Applicant: Industrial Artificial Intelligence Inc., Palo Alto, CA (US)

(72) Inventors: Shaozhi Ye, Cupertino, CA (US); Siming Li, Palo Alto, CA (US); Wei Dong, Ann Arbor, MI (US)

(73) Assignee: Industrial Artificial Intelligence Inc.

(21) Appl. No.: 17/498,000

(22) Filed: Oct. 11, 2021

(51) Int. Cl. G06Q 10/06; G06Q 10/04; G06Q 10/08

(52) U.S. Cl. CPC G06Q 10/06315; G06Q 10/04; G06Q 10/0832; G06Q 10/08345; G06Q 10/087

(57) ABSTRACT

A system and method for facilitating a transporting process is disclosed. The method includes receiving a request from a customer for shipping one or more products and determining a demand forecast corresponding to the one or more products based on the received request. The method includes determining number of one or more desired trailers and number of products based one or more cost factors, the received request and the determined demand forecast. The method includes determining number of one or more vehicles and number of round trips and generating a source sorting plan. The method also includes determining number of sorting slots required for sorting the one or more products and generate a transportation sorting plan. Further, the method includes outputting the determined number of sorting slots and the generated transportation sorting plan on a graphical user interface of one or more electronic devices.

### FIELD OF INVENTION

Embodiments of the present disclosure relate to a transportation system and more particularly relates to a system and a method for facilitating a transporting process.

### BACKGROUND

With the advancements in technology, customers including individuals and businesses may place orders for a plurality of products, such that the plurality of products are packaged and shipped to the customers as quickly as possible. Conventionally, when a customer places an order, one or more products corresponding to the order are loaded into trailers and the trailers loaded with the one or more products are transported from a warehouse centre to a sorting centre via human driven trucks. Further, the sorting centre packs the one or more products and sorts the packaged one or more products according to customer address of the customer. However, the conventional method of packing and sorting the one or more products at the sorting centre is an expensive and time-consuming process due to the requirement of numerous sorting slots and large sorting machine. Thus, there is a high likelihood of delay in shipment of the order. Since, the transportation of the one or more products from the warehouse centre to the sorting centre is performed by the human driven trucks, overall cost of transportation is high. Generally, drivers driving the human driven trucks require multiple breaks to rest their body due to which the transporting process may be slowed down and there may be a significant delay in shipment of the orders.

Hence, there is a need for a system and method for facilitating a transporting process in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computing system for facilitating a transporting process is disclosed. The computing system includes one or more hardware processors and a memory coupled to the one or more hardware processors. The memory includes a plurality of modules in the form of programmable instructions executable by the one or more hardware processors. The plurality of modules include a request receiver module configured to receive a request from a customer for shipping one or more products from a warehouse centre. The request includes types of the one or more products, quantity of each of the one or more products and a customer address. The plurality of modules also include a forecast determination module configured to determine a demand forecast corresponding to the one or more products based on the received request. The plurality of modules further include a transportation management module configured to determine number of one or more desired trailers and number of products to be sorted for each Stock Keeping Unit (SKU) into each desired trailer based on one or more cost factors and at least one of: the received request and the determined demand forecast. Also, the transportation management module is configured to determine number of one or more vehicles required for transporting the one or more products from the source location to the destination location and number of round trips between the source location and the destination location based on the determined number of one or more desired trailers, travel distance between the source location and the destination location, the one or more cost factors and desired shipping time of the one or more products. The transportation management module is configured to generate a source sorting plan matching the number of one or more vehicles required for transportation based on the determined number of one or more desired trailers, the travel distance between the source location and the destination location, the one or more cost factors and the desired shipping time of the one or more products. Furthermore, the transportation management module is configured to determine number of sorting slots required for sorting the one or more products and generate a transportation sorting plan based on the determined number of one or more desired trailers, determined number of products to be sorted for each SKU into each desired trailer, arrival time of the one or more vehicles and the one or more products to be shipped. The transportation sorting plan includes: the number of one or more desired trailers, the number of products to be sorted for each SKU into each desired trailer, the determined number of one or more vehicles required for transporting the one or more products and the generated source sorting plan. Also, the plurality of modules include a data output module configured to output the determined number of sorting slots and the generated transportation sorting plan on a graphical user interface of one or more electronic devices associated with authorized personnel of the warehouse centre and the sorting centre.

In accordance with another embodiment of the present disclosure, a method for facilitating a transporting process is disclosed. The method includes receiving a request from a customer for shipping one or more products from a warehouse centre. The request includes types of the one or more products, quantity of each of the one or more products and a customer address. The method also includes determining a demand forecast corresponding to the one or more products based on the received request. The method further includes determining number of one or more desired trailers and number of products to be sorted for each Stock Keeping Unit (SKU) into each desired trailer based on one or more cost factors and at least one of: the received request and the determined demand forecast. Further, the method includes determining number of one or more vehicles required for transporting the one or more products from source location to destination location and number of round trips between the source location and the destination location based on the determined number of one or more desired trailers, travel distance between the source location and the destination location, the one or more cost factors and desired shipping time of the one or more products. The method includes generating a source sorting plan matching the number of one or more vehicles required for transportation based on the determined number of one or more desired trailers, the travel distance between the source location and the destination location, the one or more cost factors and the desired shipping time of the one or more products. Also, the method includes determining number of sorting slots required for sorting the one or more products and generate a transportation sorting plan based on the determined number of one or more desired trailers, the determined number of products to be sorted for each SKU into each desired trailer, arrival time of the one or more vehicles and the one or more products to be shipped. The transportation sorting plan includes: the number of one or more desired trailers, the number of products to be sorted for each SKU into each desired trailer, the determined number of one or more vehicles required for transporting the one or more products and the generated source sorting plan. Furthermore, the method includes outputting the determined number of sorting slots and the generated transportation sorting plan on a graphical user interface of one or more electronic devices associated with authorized personnel of the warehouse centre and the sorting centre.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary transporting environment capable of facilitating a transporting process, in accordance with an embodiment of the present disclosure;

FIG. 2 is a block diagram illustrating an exemplary computing system, such as those shown in FIG. 1, capable of facilitating the transporting process, in accordance with an embodiment of the present disclosure; and

FIG. 3 is a process flow diagram illustrating an exemplary method for facilitating the transporting process, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

Although the explanation is limited to a single customer, it should be understood by the person skilled in the art that the computing system is applied if there are more than one customer.

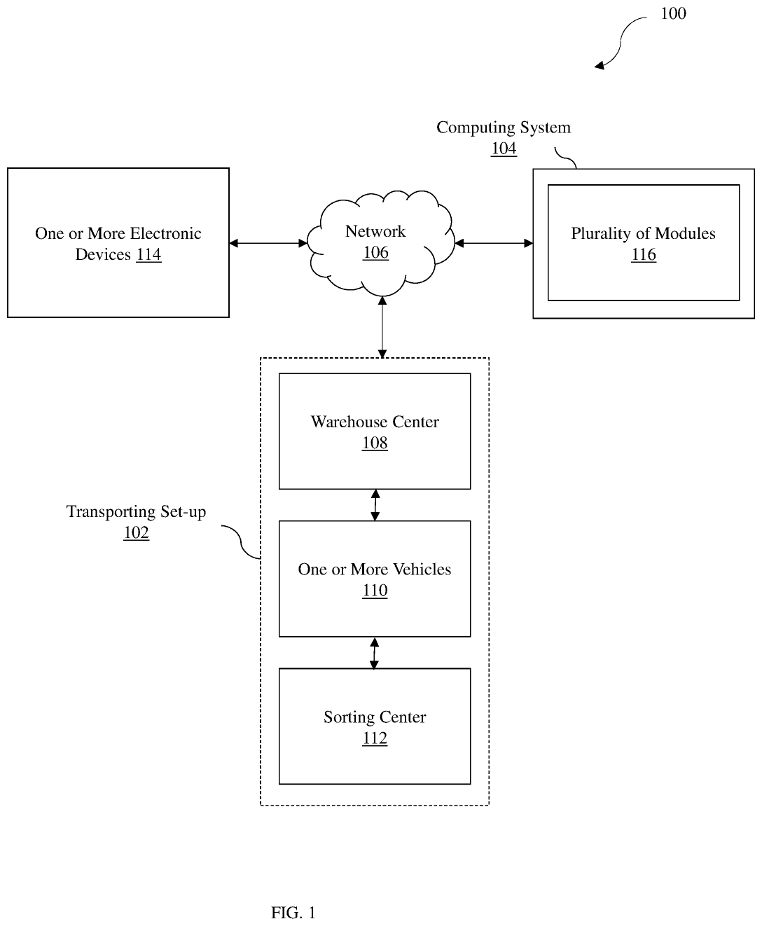

Referring now to the drawings, and more particularly to FIG. 1 through FIG. 3, where similar reference characters denote corresponding features consistently throughout the figures, there are shown preferred embodiments and these embodiments are described in the context of the following exemplary system and/or method.

FIG. 1 is a block diagram illustrating an exemplary transporting environment 100 capable of facilitating a transporting process, in accordance with an embodiment of the present disclosure. According to FIG. 1, the transporting environment 100 includes a transporting set-up 102 communicatively coupled to a computing system 104 via a network 106. The transporting set-up 102 includes a warehouse centre 108, one or more vehicles 110 and a sorting centre 112. In an exemplary embodiment of the present disclosure, the one or more vehicles 110 may be self-driven trucks. The warehouse centre 108 stores products to be delivered to customers. When a customer request shipment of one or more products from the warehouse centre 108, the one or more products are loaded into one or more trailers, such that the one or more trailers loaded with the one or more products are transported from the warehouse centre 108 to the sorting centre 112 via the one or more vehicles 110. In an exemplary embodiment of the present disclosure, the request includes types of the one or more products, quantity of each of the one or more products and a customer address. Further, the sorting centre 112 packs the one or more products into parcels and sorts the parcels according to the customer address of the customer. In an exemplary embodiment of the present disclosure, the network 106 may be internet. The computing system 104 may be a central server, such as cloud server or a remote server. Furthermore, small trucks may collect the parcels from the sorting centre 112 and transport the parcels from the sorting centre 112 to the customer address.

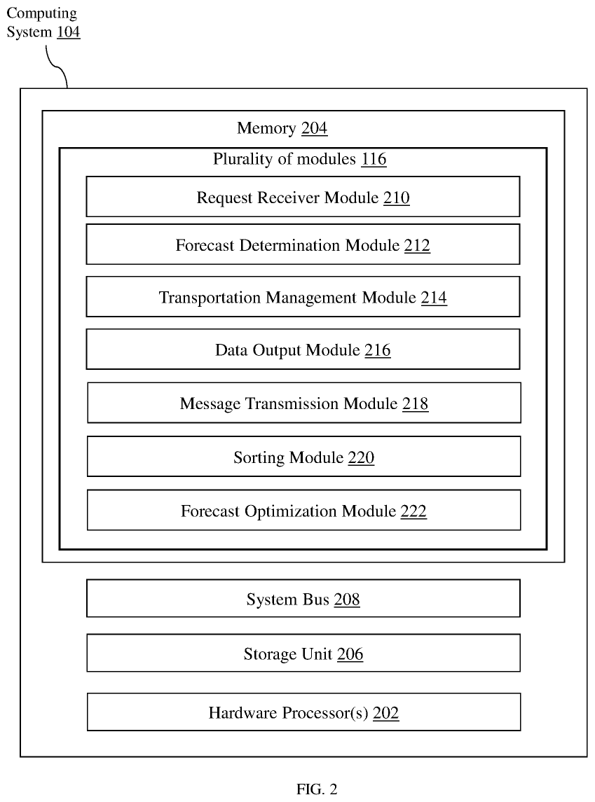

Further, the transporting environment 100 includes one or more electronic devices 114 associated with authorized personnel of the warehouse centre 108 and the sorting centre 112 communicatively coupled to the computing system 104 via the network 106. In an exemplary embodiment of the present disclosure, the one or more electronic devices 114 may be a laptop computer, desktop computer, tablet computer, smartphone, wearable device, smart watch and the like. In an embodiment of the present disclosure, the authorized personnel may use the one or more electronic devices 114 for the purpose of receiving number of sorting slots required for sorting the one or more products and generate a transportation sorting plan for facilitating the transporting process. Furthermore, the computing system 104 includes a plurality of modules 116. Details on the plurality of modules 116 have been elaborated in subsequent paragraphs of the present description with reference to FIG. 2.

In an embodiment of the present disclosure, the computing system 104 is configured to receive a request from the customer for shipping the one or more products from the warehouse centre 108. The computing system 104 determines a demand forecast corresponding to the one or more products based on the received request. Further, the computing system 104 also determines number of one or more desired trailers and number of products to be sorted for each Stock Keeping Unit (SKU) into each desired trailer based on the one or more cost factors and the received request, the determined demand forecast or any combination thereof. The computing system 104 determines number of one or more vehicles 110 required for transporting the one or more products from source location to destination location and number of round trips between source location and destination location based on the determined number of one or more desired trailers, travel distance between the source location and the destination location, the one or more cost factors and desired shipping time of the one or more products. The computing system 104 generates a source sorting plan matching the number of one or more vehicles 110 required for transportation based on the determined number of one or more desired trailers, the travel distance between the source location and the destination location, the one or more cost factors and the desired time of shipping the one or more products. Furthermore, the computing system 104 determines number of sorting slots required for sorting the one or more products and generate a transportation sorting plan based on the determined number of one or more desired trailers, determined number of products to be sorted for each SKU into each desired trailer, arrival time of one or more vehicles 110 and the one or more products to be shipped. The transportation sorting plan includes the number of one or more desired trailers, the number of products to be sorted for each SKU into each desired trailer, the number of one or more vehicles 110 required for transporting the one or more products and the source sorting plan. The computing system 104 outputs the determined number of sorting slots and the generated transportation sorting plan on a graphical user interface of the one or more electronic devices 114 associated with the authorized personnel of the warehouse centre 108 and the sorting centre 112.

FIG. 2 is a block diagram illustrating an exemplary computing system 104, such as those shown in FIG. 1, capable of facilitating a transporting process. The computing system 104 comprises one or more hardware processors 202, a memory 204 and a storage unit 206. The one or more hardware processors 202, the memory 204 and the storage unit 206 are communicatively coupled through a system bus 208 or any similar mechanism. The memory 204 comprises the plurality of modules 116 in the form of programmable instructions executable by the one or more hardware processors 202. Further, the plurality of modules 116 includes a request receiver module 210, a forecast determination module 212, a transportation management module 214, a data output module 216, a message transmission module 218, a sorting module 220, a forecast optimization module 222.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of modules 116 stored in the form of machine-readable instructions on any of the above-mentioned storage media and may be in communication with and executed by the one or more hardware processors 202.

The storage unit 206 may be a cloud storage. The storage unit 206 may store information about availability of products in the warehouse centre 108, types of the products, weight and volume of each product, demand forecast corresponding to one or more products, the one or more cost factors, predefined information, transportation sorting plan and predefined threshold associated with desired trailer.

The request receiver module 210 is configured to receive a request from a customer for shipping one or more products from a warehouse centre 108. The request includes types of the one or more products, quantity of each of the one or more products and a customer address.

The forecast determination module 212 is configured to determine a demand forecast corresponding to the one or more products based on the received request. In determining the demand forecast corresponding to the one or more products based on the received request, the forecast determination module 212 estimates quantity of each of the one or more products required by the customer. In an embodiment of the present disclosure, the forecast determination module 212 estimates quantity of each of the one or more products corresponding to each SKU for the purpose of shipping the one or more products in each cycle. The cycle is a time-period determined based on round trip of the one or more vehicles 110 between the warehouse centre 108 and the sorting centre 112. In an exemplary embodiment of the present disclosure, the cycle may be daily or hourly. Since, the quantity of each of the one or more products may be estimated corresponding to each cycle, the estimated quantity of each of the one or more products may be changed based on customer demand. For example, when the customer demand increases, the estimated quantity of each of the one or more products may also be increased. Further, the forecast determination module 212 determines weight and volume of each of the one or more products based on predefined information. The forecast determination module 212 calculates total volume and total weight corresponding to each of the one or more products based on the estimated quantity and determined weight. For example, when a customer requires N quantity of a product P whose volume is v and weight is w, total volume and total weight of N quantity of the product P is N*v and N*w, respectively.

The transportation management module 214 is configured to determine number of one or more desired trailers and number of products to be sorted for each Stock Keeping Unit (SKU) into each desired trailer based on the one or more cost factors and the received request, the determined demand forecast or a combination thereof. In an exemplary embodiment of the present disclosure, the one or more cost factors include vehicle cost, trailer cost, fuel cost and the like. For example, only one type of product may be loaded in a desired trailer to reduce sorting cost at the sorting centre 112. In determining the number of one or more desired trailers and the number of products to be sorted for each SKU into each desired trailer based on the one or more cost factors and the received request, the determined demand forecast or a combination thereof, the transportation management module 214 validates if the total volume and the total weight corresponding to each of the one or more products is greater than the predefined threshold by comparing the total volume and the total weight corresponding to each of the one or more products with predefined threshold associated with desired trailer. In an embodiment of the present disclosure, the predefined threshold may be a break-even point for loading a product in the desired trailer in order to earn profit from the transportation of the product. The predefined threshold may be less than maximum loading capacity of the desired trailer. The predefined threshold is calculated based on the one or more cost factors. In an embodiment of the present disclosure, one or more cost factors associated with transportation of the one or more products may be summed up, such that the summed-up cost may be compared to a desired shipping cost to calculate the predefined threshold. The desired shipping cost may be cost of transporting the one or more products from the source location to the destination location. Further, the transportation management module 214 generates a notification for instructing the authorized personnel to load each product in a separate desired trailer upon validating that the total volume and the total weight corresponding to each of the one or more products is greater than the predefined threshold. When the authorized personnel load each product in a separate desired trailer, the number of SKUs in each vehicle is minimized Thus, the requirement of sorting slots at the sorting centre 112 may be reduced resulting in smaller sorting centre 112 and devices. In an embodiment of the present disclosure, the devices are sorting machines. In an embodiment of the present disclosure, when the number of SKUs in each vehicle is reduced, sorting cost decreases and number of one or more vehicles 110 required to transport the one or more products from the warehouse centre 108 to the sorting centre 112 increases. Furthermore, when the number of SKUs in each vehicle is increased, sorting cost increases and number of vehicles required to transport the one or more products from the warehouse centre 108 to the sorting centre 112 decreases. Since, sorting capacity of the sorting centre 112 is fixed, the transportation management module 214 may give more priority to the sorting cost while determining the number of one or more desired trailers and the number of products to be sorted, such that the number of SKUs in each vehicle may be minimized to reduce the sorting cost. The transportation management module 214 generates a notification for instructing the authorized personnel to load multiple products from the one or more products in the desired trailer upon validating that the total volume and the total weight corresponding to each of the one or more products is less than the predefined threshold. In an embodiment of the present disclosure, the weight and volume of the multiple products is more than the predefined threshold. Further, the data output module 216 outputs the generated notifications on a graphical user interface of the one or more electronic devices 114 associated with the authorized personnel. In an embodiment of the present disclosure, the multiple products loaded in the desired trailer may be separated from each other via one or more means to ease the sorting process at the sorting centre 112. In an exemplary embodiment of the present disclosure, the one or more means may include nets, covers and the like.

Further, the transportation management module 214 determines number of one or more vehicles 110 required for transporting one or more products from source location to destination location and number of round trips between source location and destination location based on the determined number of one or more desired trailers, travel distance between the source location and the destination location, the one or more cost factors and desired shipping time of the one or more products. The transportation module also generates a source sorting plan matching the number of one or more vehicles 110 required for transportation based on the determined number of one or more desired trailers, the travel distance between the source location and the destination location, the one or more cost factors and the desired shipping time of the one or more products. The desired shipping time is a time period within which the one or more products must be delivered to the customer. The source location is the warehouse centre 108 and the destination location is the sorting centre 112. The transportation management module 214 may determine the number of one or more vehicles 110 corresponding to the one or more desired trailers, such that each vehicle may make a single round trip or multiple round trips. In an embodiment of the present disclosure, the transportation management module 214 may determine the number of one or more vehicles 110, such that cost of the transportation of the one or more products may be reduced and the one or more products may be shipped in accordance with the desired shipping time. For example, when each vehicle may cost T, each round trip between the source location and the destination location may cost T′, number of the one or more vehicles 110 may be N and total round trips may be K, the total cost of the transportation may be T*N+T′ K. The total volume is divided by the one or more vehicles' load capacity to get lower bound of K. Further, an upper bound of N is Kl assuming the one or more products are shipped to destination in one trip. In an embodiment of the present disclosure, value of T and T′ are constants based on type of the one or more vehicles 110 and the distance between the source location and destination location. The total cost of the transportation may be reduced by enumerating various combinations of N and K when search space is small. The total cost may also be reduced via newton's method as it is a convex function at least within a small window. W can sample multiple starting point to avoid local maximum. The newton's method is used to solve optimization problems over the convex function. The newton's method starts with a random position and then it advances with a moving interval calculated in the process of calculating the total cost. In an embodiment of the present disclosure, local maximum may be avoided by using the newton's method. In an embodiment of the present disclosure, k times each vehicle's load capacity may be greater than the total volume and the total weight required to be transported. In an embodiment of the present disclosure, the value of N is enumerated from 1 to Kl and the required number of total round trips are computed based on the one or more cost factors. Further, the total cost of the transportation may be calculated based on the computed total number of round trips. Each vehicle is required to return to the source location. Since, the one or more products are required to be shipped in accordance with the desired shipping time, search space for solution is greatly limited. For example, when a user is required to finish shipping in 24 hours and each trip to destination consumes 4 hours, the user can manage to complete 6 round trips. Thus, value of the search space for the total number of round trips may range from 1 to 6.

In an embodiment of the present disclosure, when the one or more vehicles 110 transport the one or more products from the warehouse centre 108 to the sorting centre 112, the one or more desired trailers may be used as warehouse if no sorting is required. Furthermore, when the one or more vehicles 110 unload the one or more desired trailers, the one or more vehicles 110 may leave for next transportation task. The transportation management module 214 determines number of sorting slots required for sorting the one or more products and generate a transportation sorting plan based on the determined number of one or more desired trailers, determined number of products to be sorted for each SKU into each desired trailer, arrival time of the one or more vehicles 110 and the one or more products to be shipped. The transportation sorting plan includes the number of one or more desired trailers, the number of products to be sorted for each SKU into each desired trailer, the number of one or more vehicles 110 required for transporting the one or more products and the source sorting plan. The transportation sorting plan is required to match with the one or more desired trailers and the one or more products. In an embodiment of the present disclosure, the one or more products may be sorted by a first come first serve algorithm to sort available inbound products first. Further, the one or more products may be sorted based on their respective desired shipping time. In an exemplary embodiment of the present disclosure, the number of sorting slots may be up to the types of the one or more products. In an embodiment of the present disclosure, the number of SKUs may be enumerated (the upper bound of S) down to 1. For each value of S, the corresponding sorting time may be T=number of total SKUs/S*time for the sorting machine to perform one pass of sorting to the inbound products. In an embodiment of the present disclosure, T is required to be within the required shipping time to the end customer minus estimated transportation from the sorting center to location of the customer.

The data output module 216 is configured to output the determined number of sorting slots and the generated transportation sorting plan on the graphical user interface of the one or more electronic devices 114 associated with authorized personnel of the warehouse centre 108 and the sorting centre 112.

The message transmission module 218 is configured to identify one or more vehicles 110 available for transporting the one or more products from the source location to the destination location. Further, the message transmission module 218 transmits one or more messages indicating the generated transportation sorting plan and the sorting slots to the identified one or more vehicles 110 for transporting the one or more products from the source location to the destination location. In an embodiment of the present disclosure, the message transmission module 218 may transmit the one or more messages to the identified one or more vehicles 110 via the network 106.

The sorting module 220 is configured to validate if the number of sorting slots are less than the types of one or more products by comparing the number of sorting slots with the types of one or more products. Further, the sorting module 220 generates a notification for instructing the authorized personnel to perform multi-batch sorting upon validating that the number of sorting slots are less than the types of one or more products. The multi-batch sorting is performed as the one or more products may not be sorted in a single batch. In an embodiment of the present disclosure, the sorting machine is fed with only those product which are required to be shipped to the customer. These products are taken out of their dedicated trailer boxes instead of a mixed box, where the products which are not required to be shipped to the customer may be fed to the sorting machine. Thus, the sorting machine may sort these products into parcels without leaving any product unparcelled as no customer requires it. The output module outputs the generated notification on the graphical user interface of the one or more electronic devices 114 associated with the authorized personnel. In an embodiment of the present disclosure, the one or more products required by the customer may be sorted based on popularity of each of the one or more products and the customer address. In an embodiment of the present disclosure, the total sorting time may be devised by sorting the one or more products required by the customer according to their popularity with most popular products first. With fixed batch size S, combined with packing time for each product, the batch processing time is S*time required to pack a product. In am embodiment of the present disclosure, all products require the same time to pack. The packing time variance may be accommodated by using an average packing time. The aforementioned steps may be repeated until all customer requests are exhausted, which adds up the total sorting time. For a particular size of processing area, the upper bound for S (physical constraint) is the processing area divided by the average floor space a product takes. When the one or more products are stacked-up, S may be further increased. However, it is not required to stack the one or more products. In an embodiment of the present disclosure, it is impossible to stack some products due to their shape or being fragile. In an embodiment of the present disclosure, minimum S is searched by reducing S linearly and computing the total processing time. When the total processing time fails to satisfy the shipping time constraint, reduction in S is stopped and minimum value of S is obtained.

The forecast optimization module 222 is configured to optimize the demand forecast based on the request received from the customer. In an embodiment of the present disclosure, the forecast optimization module 222 may optimize the demand forecast by updating the demand forecast based on the received request. In updating the forecast based on the received request, the forecast optimization module 222 modifies the estimated quantity of the one or more products based on the received request including the types of the one or more products and the quantity of each of the one or more products. In an embodiment of the present disclosure, updating the demand forecast based on the received request may be a slow process if the one or more products may already be loaded into the one or more desired trailers. The forecast optimization module 222 may also optimize the demand forecast by generating a notification for instructing the authorized personnel to load a set of products corresponding to the received request in a desired trailer of the one or more desired trailers for transporting the set of products from the source location to the destination location. The set of products may be additional products corresponding to the request received from the customer. The data output module 216 outputs the generated notification on the graphical user interface of the one or more electronic devices 114 associated with the authorized personnel. In an embodiment of the present disclosure, in generating the notification for instructing the authorized personnel to load the set of products corresponding to the received request in the desired trailer is fast process as there is no requirement of modifying the estimated quantity of the one or more products. It may also reduce the sorting cost at the sorting centre 112 and increase sorting cost at the warehouse centre 108 as the set of products are required to be sorted at the warehouse centre 108 according to the customer address. Since, the set of products may be loaded in the desired trailer of the one or more desired trailers, the transportation cost does not increase. In an embodiment of the present disclosure, when the one or more desired trailers may not have sufficient space to load the set of products, additional desired trailers may be used to transport the set of products from the warehouse centre 108 to the sorting centre 112. In an embodiment of the present disclosure, the demand forecast may be optimized for batch, small order fulfillment or a combination thereof.

In operation, the computing system 104 receives the request from the customer for shipping the one or more products from the warehouse centre 108. The customer may generate and send the request by using an electronic device, such as laptop computer, desktop computer, tablet computer, smartphone, wearable device, smart watch and the like. Further, the computing system 104 determines the demand forecast corresponding to the one or more products based on the received request. In determining the demand forecast, the computing system 104 calculates the total volume and the total weight corresponding to each of the one or more products. The computing system 104 may also optimize the demand forecast based on the received request. Furthermore, the computing system 104 determines the number of one or more desired trailers and the number of products to be sorted for each SKU into each desired trailer based on one or more cost factors and the received request, the determined demand forecast or any combination thereof. The computing system 104 further determines the number of one or more vehicles 110 required for transporting the one or more products from source location to destination location and the number of round trips between source location and destination location based on the determined number of one or more desired trailers, the travel distance between the source location and the destination location, the one or more cost factors and the desired shipping time of the one or more products. The computing system 104 also generates the source sorting plan matching the number of one or more vehicles 110 required for transportation based on the determined number of one or more desired trailers, the travel distance between the source location and the destination location, the one or more cost factors and the desired shipping time of the one or more products. Further, the computing system 104 determines number of sorting slots required for sorting the one or more products and generate the transportation sorting plan based on the determined number of one or more desired trailers, determined number of products to be sorted for each SKU into each desired trailer, arrival time of the one or more vehicles 110 and the one or more products to be shipped. The computing system 104 also outputs the determined number of sorting slots and the generated transportation sorting plan on the graphical user interface of the one or more electronic devices 114 associated with authorized personnel of the warehouse centre 108 and the sorting centre 112.

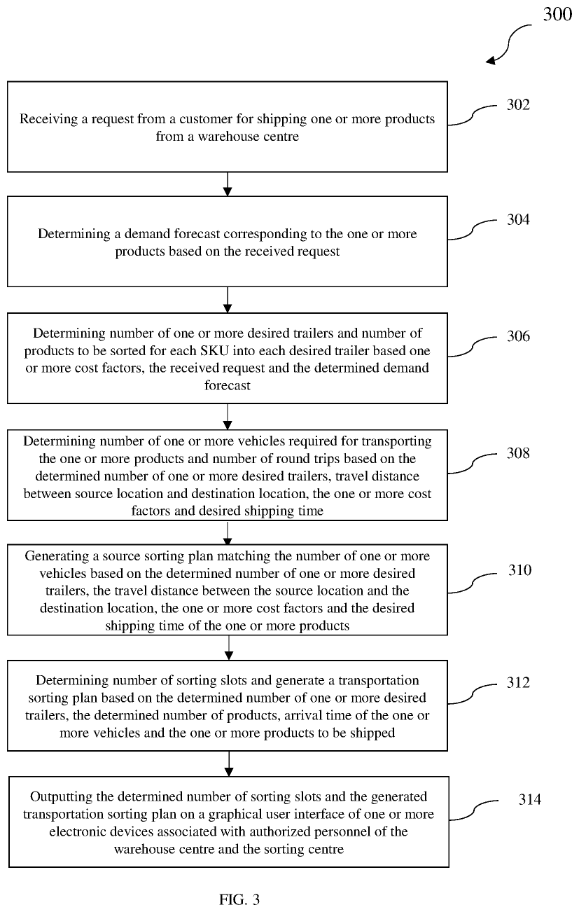

FIG. 3 is a process flow diagram illustrating an exemplary method 300 for facilitating a transporting process, in accordance with an embodiment of the present disclosure. At step 302, a request is received from a customer for shipping one or more products from a warehouse centre 108. The request includes types of the one or more products, quantity of each of the one or more products and a customer address.

At step 304, a demand forecast is determined corresponding to the one or more products based on the received request. In determining the demand forecast corresponding to the one or more products based on the received request, the method 300 includes estimating quantity of each of the one or more products required by the customer. In an embodiment of the present disclosure, quantity of each of the one or more products is estimated corresponding to each SKU for the purpose of shipping the one or more products in each cycle. The cycle is a time-period determined based on round trip of the one or more vehicles 110 between warehouse centre 108 and sorting centre 112. In an exemplary embodiment of the present disclosure, the cycle may be daily or hourly. Since, the quantity of each of the one or more products may be estimated corresponding to each cycle, the estimated quantity of each of the one or more products may be changed based on customer demand. For example, when the customer demand increases, the estimated quantity of each of the one or more products may also be increased. Further, the method 300 includes determining weight and volume of each of the one or more products based on predefined information. The method 300 includes calculating total volume and total weight corresponding to each of the one or more products based on the estimated quantity and determined weight. For example, when a customer requires N quantity of a product P whose volume is v and weight is w, total volume and weight of N quantity of the product P is N*v and N*w, respectively.

At step 306, number of one or more desired trailers and number of products to be sorted for each Stock Keeping Unit (SKU) into each desired trailer are determined based one or more cost factors and the received request, the determined demand forecast or a combination thereof. In an exemplary embodiment of the present disclosure, the one or more cost factors include vehicle cost, trailer cost, fuel cost and the like. For example, only one type of product may be loaded in a desired trailer to reduce sorting cost at the sorting centre 112. In determining the number of one or more desired trailers and the number of products to be sorted for each SKU into each desired trailer based on the one or more cost factors and the received request, the determined demand forecast or a combination thereof, the method 300 includes validating if the total volume and the total weight corresponding to each of the one or more products is greater than the predefined threshold by comparing the total volume and the total weight corresponding to each of the one or more products with predefined threshold associated with desired trailer. In an embodiment of the present disclosure, the predefined threshold may be a break-even point for loading a product in the desired trailer in order to earn profit from the transportation of the product. The predefined threshold may be less than maximum loading capacity of the desired trailer. The predefined threshold is calculated based on the one or more cost factors. In an embodiment of the present disclosure, one or more cost factors associated with transportation of the one or more products may be summed up, such that the summed-up cost may be compared to a desired shipping cost to calculate the predefined threshold. The desired shipping cost may be cost of transporting the one or more products from the source location to the destination location. Further, the method 300 includes generating a notification for instructing the authorized personnel to load each product in a separate desired trailer upon validating that the total volume and the total weight corresponding to each of the one or more products is greater than the predefined threshold. When the authorized personnel load each product in a separate desired trailer, the number of SKUs in each vehicle is minimized Thus, the requirement of sorting slots at the sorting centre 112 may be reduced resulting in smaller sorting centre 112 and devices. In an embodiment of the present disclosure, the devices are sorting machines. In an embodiment of the present disclosure, when the number of SKUs in each vehicle is reduced, sorting cost decreases and number of one or more vehicles 110 required to transport the one or more products from the warehouse centre 108 to the sorting centre 112 increases. Furthermore, when the number of SKUs in each vehicle is increased, sorting cost increases and number of vehicles required to transport the one or more products from the warehouse centre 108 to the sorting centre 112 decreases. Since, sorting capacity of the sorting centre 112 is fixed, more priority may be given to the sorting cost while determining the number of one or more desired trailers and the number of products to be sorted, such that the number of SKUs in each vehicle may be minimized to reduce the sorting cost. The method 300 includes generating a notification for instructing the authorized personnel to load multiple products from the one or more products in the desired trailer upon validating that the total volume and the total weight corresponding to each of the one or more products is less than the predefined threshold. In an embodiment of the present disclosure, the weight and volume of the multiple products is more than the predefined threshold. Further, the method 300 includes outputting the generated notifications on graphical user interface of the one or more electronic devices 114 associated with the authorized personnel. In an embodiment of the present disclosure, the multiple products loaded in the desired trailer may be separated from each other via one or more means to ease the sorting process at the sorting centre 112. In an exemplary embodiment of the present disclosure, the one or more means may include nets, covers and the like.

At step 308, number of one or more vehicles 110 required for transporting one or more products from source location to destination location and number of round trips between the source location and the destination location may be determined based on the determined number of one or more desired trailers, travel distance between the source location and the destination location, the one or more cost factors and desired shipping time of the one or more products. At step 310, a source sorting plan matching the number of one or more vehicles 110 required for transportation is generated based on the determined number of one or more desired trailers, the travel distance between the source location and the destination location, the one or more cost factors and the desired shipping time of the one or more products. In an exemplary embodiment of the present disclosure, the one or more vehicles 110 may be self-driven trucks. The desired shipping time is a time period within which the one or more products must be delivered to the customer. The source location is the warehouse centre 108 and the destination location is the sorting centre 112. The number of one or more vehicles 110 may be determined corresponding to the one or more desired trailers, such that each vehicle may make a single round trip or multiple round trips. In an embodiment of the present disclosure, the number of one or more vehicles 110 may be determined, such that cost of the transportation of the one or more products may be reduced and the one or more products may be shipped in accordance with the desired shipping time. For example, when each vehicle may cost T, each round trip between the source location and the destination location may cost T′, number of the one or more vehicles 110 may be N and total round trips may be K, the total cost of the transportation may be T*N+T′K. The total volume is divided by the one or more vehicles' load capacity to get lower bound of K. Further, an upper bound of N is Kl assuming the one or more products are shipped to destination in one trip. In an embodiment of the present disclosure, value of T and T′ are constants based on type of the one or more vehicles 110 and the distance between the source location and destination location. The total cost of the transportation may be reduced by enumerating various combinations of N and K when search space is small. The total cost may also be reduced via newton's method as it is a convex function at least within a small window. W can sample multiple starting point to avoid local maximum. The newton's method is used to solve optimization problems over the convex function. The newton's method starts with a random position and then it advances with a moving interval calculated in the process of calculating the total cost. In an embodiment of the present disclosure, local maximum may be avoided by using the newton's method. In an embodiment of the present disclosure, k times each vehicle's load capacity may be greater than the total volume and the total weight required to be transported. In an embodiment of the present disclosure, the value of N is enumerated from 1 to Kl and the required number of total round trips are computed based on the one or more cost factors. Further, the total cost of the transportation may be calculated based on the computed total number of round trips. Each vehicle is required to return to the source location. Since, the one or more products are required to be shipped in accordance with the desired shipping time, search space for solution is greatly limited. For example, when a user is required to finish shipping in 24 hours and each trip to destination consumes 4 hours, the user can manage to complete 6 round trips. Thus, value of the search space for the total number of round trips may range from 1 to 6. In an embodiment of the present disclosure, when the one or more vehicles 110 transport the one or more products from the warehouse centre 108 to the sorting centre 112, the one or more desired trailers may be used as warehouse if no sorting is required. Furthermore, when the one or more vehicles 110 unload the one or more desired trailers, the one or more vehicles 110 may leave for next transportation task.

At step 312, number of sorting slots required for sorting the one or more products are determined and a transportation sorting plan is generated based on the determined number of one or more desired trailers, determined number of products to be sorted for each SKU into each desired trailer, arrival time of the one or more vehicles 110 and the one or more products to be shipped. The transportation sorting plan includes the number of one or more desired trailers, the number of products to be sorted for each SKU into each desired trailer, the number of one or more vehicles 110 required for transporting the one or more products and the source sorting plan. The transportation sorting plan is required to match with the one or more desired trailers and the one or more products. In an embodiment of the present disclosure, the one or more products may be sorted by a first come first serve algorithm to sort available inbound products first. Further, the one or more products may be sorted based on their respective desired shipping time. In an exemplary embodiment of the present disclosure, the number of sorting slots may be up to the types of the one or more products. In an embodiment of the present disclosure, the number of SKUs may be enumerated (the upper bound of S) down to 1. For each value of S, the corresponding sorting time may be T=number of total SKUs/S*time for the sorting machine to perform one pass of sorting to the inbound products. In an embodiment of the present disclosure, T is required to be within the required shipping time to the end customer minus estimated transportation from the sorting center to location of the customer.

At step 314, the determined number of sorting slots and the generated transportation sorting plan are outputted on graphical user interface of one or more electronic devices 114 associated with authorized personnel of the warehouse centre 108 and the sorting centre 112. In an exemplary embodiment of the present disclosure, the one or more electronic devices 114 may be a laptop computer, desktop computer, tablet computer, smartphone, wearable device, smart watch and the like.

Further, the method includes 300 identifying one or more vehicles 110 available for transporting the one or more products from the source location to the destination location. Further, the method includes 300 transmitting one or more messages indicating the generated transportation sorting plan and the sorting slots to the identified one or more vehicles 110 for transporting the one or more products from the source location to the destination location. In an embodiment of the present disclosure, the one or more messages may be transmitted to the identified one or more vehicles 110 via the network 106.

Furthermore, the method includes 300 validating if the number of sorting slots are less than the types of one or more products by comparing the number of sorting slots with the types of one or more products. Further, the method includes 300 generating a notification for instructing the authorized personnel to perform multi-batch sorting upon validating that the number of sorting slots are less than the types of one or more products. The multi-batch sorting is performed as the one or more products may not be sorted in a single batch. In an embodiment of the present disclosure, the sorting machine is fed with only those product which are required to be shipped to the customer. These products are taken out of their dedicated trailer boxes instead of a mixed box, where the products which are not required to be shipped to the customer may be fed to the sorting machine. Thus, the sorting machine may sort these products into parcels without leaving any product unparcelled as no customer requires it. The method includes 300 outputting the generated notification on the graphical user interface of the one or more electronic devices 114 associated with the authorized personnel. In an embodiment of the present disclosure, the one or more products required by the customer may be sorted based on popularity of each of the one or more products and the customer address. In an embodiment of the present disclosure, the total sorting time may be devised by sorting the one or more products required by the customer according to their popularity with most popular products first. With fixed batch size S, combined with packing time for each product, the batch processing time is S*time required to pack a product. In an embodiment of the present disclosure, all products require the same time to pack. The packing time variance may be accommodated by using an average packing time. The aforementioned steps may be repeated until all customer requests are exhausted, which adds up the total sorting time. For a particular size of processing area, the upper bound for S (physical constraint) is the processing area divided by the average floor space a product takes. When the one or more products are stacked-up, S may be further increased. However, it is not required to stack the one or more products. In an embodiment of the present disclosure, it is impossible to stack some products due to their shape or being fragile. In an embodiment of the present disclosure, minimum S is searched by reducing S linearly and computing the total processing time. When the total processing time fails to satisfy the shipping time constraint, reduction in S is stopped and minimum value of S is obtained.

Further, the method 300 includes optimizing the demand forecast based on the request received from the customer. In an embodiment of the present disclosure, the method 300 includes optimizing the demand forecast by updating the demand forecast based on the received request. In updating the demand forecast based on the received request, the method 300 includes modifying the estimated quantity of the one or more products based on the received request including the types of the one or more products and the quantity of each of the one or more products. In an embodiment of the present disclosure, updating the demand forecast based on the received request may be a slow process if the one or more products may already be loaded into the one or more desired trailers. The method 300 may also include optimizing the demand forecast by generating a notification for instructing the authorized personnel to load a set of products corresponding to the received request in a desired trailer of the one or more desired trailers for transporting the set of products from the source location to the destination location. The set of products may be additional products corresponding to the request received from the customer. The method 300 includes outputting the generated notification on the graphical user interface of the one or more electronic devices 114 associated with the authorized personnel. In an embodiment of the present disclosure, in generating the notification for instructing the authorized personnel to load the set of products corresponding to the received request in the desired trailer is fast process as there is no requirement of modifying the estimated quantity of the one or more products. It may also reduce the sorting cost at the sorting centre 112 and increase sorting cost at the warehouse centre 108 as the set of products are required to be sorted at the warehouse centre 108 according to the customer address. Since, the set of products may be loaded in the desired trailer of the one or more desired trailers, the transportation cost does not increase. In an embodiment of the present disclosure, when the one or more desired trailers may not have sufficient space to load the set of products, additional desired trailers may be used to transport the set of products from the warehouse centre 108 to the sorting centre 112. In an embodiment of the present disclosure, the demand forecast may be optimized for batch, small order fulfillment or a combination thereof.

The method 300 may be implemented in any suitable hardware, software, firmware, or combination thereof.

Thus, various embodiments of the present computing system 104 provide a solution to facilitate the transporting process. Since, the computing system 104 minimizes the number of SKUs in each desired trailer, a smaller sorting machine may be sufficient to sort the one or more products at the sorting centre 112. Thus, the sorting space, rental or buying cost of the sorting machine and number of sorting slots may be reduced. Since, the one or more vehicles 110 are self-driven trucks, drivers are not required to transport the one or more products from the source location to the destination location. Hence, cost of the overall transportation of the one or more products may be reduced. Further, transportation time may also be reduced as now the one or more vehicles 110 are not required to be stopped by the drivers for taking multiple breaks. Since, the transportation time is reduced, the one or more products may now be transported to distant routes. Also, number of sorting centre 112 may also be reduced. Furthermore, the one or more vehicles 110 are no longer required to wait for sorting the one or more products at the sorting centre 112. The one or more vehicles 110 may leave the sorting centre 112 as soon as the one or more desired trailers are dropped off at the sorting centre 112. The one or more vehicles 110 may perform other tasks after dropping off the one or more desired trailers, such as picking up a desired trailer at the sorting centre 112 which was previously dropped off. This reduces the round trip time between warehouse centre 108 and the sorting centre 112 and increases vehicle usage.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. A computing system for facilitating a transporting process, the computing system comprising:
one or more hardware processors; and
a memory coupled to the one or more hardware processors, wherein the memory comprises a plurality of modules in the form of programmable instructions executable by the one or more hardware processors, wherein the plurality of modules comprises:
a request receiver module configured to receive a request from a customer for shipping one or more products from a warehouse centre, wherein the request comprises: types of the one or more products, quantity of each of the one or more products and a customer address;
a forecast determination module configured to determine a demand forecast corresponding to the one or more products based on the received request;
a transportation management module configured to:
determine number of one or more desired trailers and number of products to be sorted for each Stock Keeping Unit (SKU) into each desired trailer based on one or more cost factors and at least one of: the received request and the determined demand forecast;
determine number of one or more vehicles required for transporting the one or more products from source location to destination location and number of round trips between the source location and the destination location based on the determined number of one or more desired trailers, travel distance between the source location and the destination location, the one or more cost factors and desired shipping time of the one or more products;
generate a source sorting plan matching the number of one or more vehicles required for transportation based on the determined number of one or more desired trailers, the travel distance between the source location and the destination location, the one or more cost factors and the desired shipping time of the one or more products;
determine number of sorting slots required for sorting the one or more products and generate a transportation sorting plan based on the determined number of one or more desired trailers, the determined number of products to be sorted for each SKU into each desired trailer, arrival time of the one or more vehicles and the one or more products to be shipped, wherein the transportation sorting plan comprises: the number of desired one or more trailers, the number of products to be sorted for each SKU into each desired trailer, the determined number of one or more vehicles required for transporting the one or more products and the generated source sorting plan; and
a data output module configured to output the determined number of sorting slots and the generated transportation sorting plan on a graphical user interface of one or more electronic devices associated with authorized personnel of the warehouse centre and the sorting centre.

2. The computing system of claim 1, further comprises a message transmission module configured to:
identify one or more vehicles available for transporting the one or more products from the source location to the destination location, wherein the one or more vehicles are self-driven trucks; and
transmit one or more messages indicating the generated transportation sorting plan and the sorting slots to the identified one or more vehicles for transporting the one or more products from the source location to the destination location.

3. The computing system of claim 1, wherein in determining the demand forecast corresponding to the one or more products based on the received request, the forecast determination module is configured to:
estimate quantity of each of the one or more products required by the customer;
determine weight and volume of each of the one or more products based on predefined information; and
calculate total volume and total weight corresponding to each of the one or more products based on the estimated quantity and determined weight.

4. The computing system of claim 1, wherein in determining the number of desired one or more trailers and the number of products to be sorted for each SKU into each desired trailer based on the one or more cost factors and at least one of: the received request and the determined demand forecast, the transportation management module is configured to:
validate if the total volume and the total weight corresponding to each of the one or more products is greater than the predefined threshold by comparing the total volume and the total weight corresponding to each of the one or more products with predefined threshold associated with desired trailer;
generate a notification for instructing the authorized personnel to load each product in a separate desired trailer upon validating that the total volume and the total weight corresponding to each of the one or more products is greater than the predefined threshold; and
generate a notification for instructing the authorized personnel to load multiple products from the one or more products in the desired trailer upon validating that the total volume and the total weight corresponding to each of the one or more products is less than the predefined threshold, wherein the weight and volume of the multiple products is more than the predefined threshold.

5. The computing system of claim 1, further comprises a sorting module configured to:
validate if the number of sorting slots are less than the types of one or more products by comparing the number of sorting slots with the types of one or more products; and
generate a notification for instructing the authorized personnel to perform multi-batch sorting upon validating that the number of sorting slots are less than the types of one or more products, wherein the generated notification is outputted on the graphical user interface of the one or more electronic devices associated with the authorized personnel.

6. The computing system of claim 3, further comprises a forecast optimization module configured to optimize the demand forecast based on the request received from the customer, wherein the forecast optimization module optimizes the demand forecast by one of:
updating the demand forecast based on the received request, wherein the demand forecast is updated by modifying the estimated quantity of the one or more products based on the received request comprising the types of the one or more products and the quantity of each of the one or more products; and
generating a notification for instructing the authorized personnel to load a set of products corresponding to the received request in a desired trailer of the one or more desired trailers for transporting the set of products from the source location to the destination location, wherein the generated notification is outputted on the graphical user interface of the one or more electronic devices associated with the authorized personnel.

7. The computing system of claim 1, wherein the source location is the warehouse centre and the destination location is sorting centre.

8. A method for facilitating a transporting process, the method comprising:
receiving, by one or more hardware processors, a request from a customer for shipping one or more products from a warehouse centre, wherein the request comprises: types of the one or more products, quantity of each of the one or more products and a customer address;
determining, by the one or more hardware processors, a demand forecast corresponding to the one or more products based on the received request;
determining, by the one or more hardware processors, number of one or more desired trailers and number of products to be sorted for each Stock Keeping Unit (SKU) into each desired trailer based one or more cost factors and at least one of: the received request and the determined demand forecast;
determining, by the one or more hardware processors, number of one or more vehicles required for transporting the one or more products from source location to destination location and number of round trips between the source location and the destination location based on the determined number of one or more desired trailers, travel distance between the source location and the destination location, the one or more cost factors and desired shipping time of the one or more products;
generating a source sorting plan matching the number of one or more vehicles required for transportation based on the determined number of one or more desired trailers, the travel distance between the source location and the destination location, the one or more cost factors and the desired shipping time of the one or more products;
determining, by the one or more hardware processors, number of sorting slots required for sorting the one or more products and generate a transportation sorting plan based on the determined number of one or more desired trailers, the determined number of products to be sorted for each SKU into each desired trailer, arrival time of the one or more vehicles and the one or more products to be shipped, wherein the transportation sorting plan comprises: the number of one or more desired trailers, the number of products to be sorted for each SKU into each desired trailer, the determined number of one or more vehicles required for transporting the one or more products and the generated source sorting plan; and
outputting, by the one or more hardware processors, the determined number of sorting slots and the generated transportation sorting plan on a graphical user interface of one or more electronic devices associated with authorized personnel of the warehouse centre and the sorting centre.

9. The method of claim 8, further comprises:
identifying one or more vehicles available for transporting the one or more products from the source location to the destination location, wherein the one or more vehicles are self-driven trucks; and
transmitting one or more messages indicating the generated transportation sorting plan and the sorting slots to the identified one or more vehicles for transporting the one or more products from the source location to the destination location.

10. The method of claim 8, wherein determining the demand forecast corresponding to the one or more products based on the received request comprises:
estimating quantity of each of the one or more products required by the customer;
determining weight and volume of each of the one or more products based on predefined information; and
calculating total volume and total weight corresponding to each of the one or more products based on the estimated quantity and determined weight.

11. The method of claim 8, wherein determining the number of one or more desired trailers and the number of products to be sorted for each SKU into each desired trailer based on the one or more cost factors and at least one of: the received request and the determined demand forecast comprises:
validating if the total volume and the total weight corresponding to each of the one or more products is greater than the predefined threshold by comparing the total volume and the total weight corresponding to each of the one or more products with predefined threshold associated with desired trailer;
generating a notification for instructing the authorized personnel to load each product in a separate desired trailer upon validating that the total volume and the total weight corresponding to each of the one or more products is greater than the predefined threshold; and
generating a notification for instructing the authorized personnel to load multiple products from the one or more products in the desired trailer upon validating that the total volume and the total weight corresponding to each of the one or more products is less than the predefined threshold, wherein the weight and volume of the multiple products is more than the predefined threshold.

12. The method of claim 8, further comprises:
validating if the number of sorting slots are less than the types of one or more products by comparing the number of sorting slots with the types of one or more products; and
generating a notification for instructing the authorized personnel to perform multi-batch sorting upon validating that the number of sorting slots are less than the types of one or more products, wherein the generated notification is outputted on the graphical user interface of the one or more electronic devices associated with the authorized personnel.

13. The method of claim 8, further comprises optimizing the demand forecast based on the request received from the customer, wherein the demand forecast is optimized by one of:
updating the demand forecast based on the received request, wherein the demand forecast is updated by modifying the estimated quantity of the one or more products based on the received request comprising the types of the one or more products and the quantity of each of the one or more products; and
generating a notification for instructing the authorized personnel to load a set of products corresponding to the received request in a desired trailer for transporting the set of products from the source location to the destination location, wherein the generated notification is outputted on the graphical user interface of the one or more electronic devices associated with the authorized personnel.

14. The method of claim 8, wherein the source location is the warehouse centre and the destination location is sorting centre.

15. A non-transitory computer-readable storage medium having instructions stored therein that, when executed by a hardware processor, cause the processor to perform the method steps comprising:
receiving, by one or more hardware processors, a request from a customer for shipping one or more products from a warehouse centre, wherein the request comprises: types of the one or more products, quantity of each of the one or more products and a customer address;
determining, by the one or more hardware processors, a demand forecast corresponding to the one or more products based on the received request;
determining, by the one or more hardware processors, number of one or more desired trailers and number of products to be sorted for each Stock Keeping Unit (SKU) into each desired trailer based one or more cost factors and at least one of: the received request and the determined demand forecast;
determining, by the one or more hardware processors, number of one or more vehicles required for transporting the one or more products from source location to destination location and number of round trips between the source location and the destination location based on the determined number of one or more desired trailers, travel distance between the source location and the destination location, the one or more cost factors and desired shipping time of the one or more products;
generating a source sorting plan matching the number of one or more vehicles required for transportation based on the determined number of one or more desired trailers, the travel distance between the source location and the destination location, the one or more cost factors and the desired shipping time of the one or more products;
determining, by the one or more hardware processors, number of sorting slots required for sorting the one or more products and generate a transportation sorting plan based on the determined number of one or more desired trailers, the determined number of products to be sorted for each SKU into each desired trailer, arrival time of the one or more vehicles and the one or more products to be shipped, wherein the transportation sorting plan comprises: the number of one or more desired trailers, the number of products to be sorted for each SKU into each desired trailer, the determined number of one or more vehicles required for transporting the one or more products and the generated source sorting plan; and
outputting, by the one or more hardware processors, the determined number of sorting slots and the generated transportation sorting plan on a graphical user interface of one or more electronic devices associated with authorized personnel of the warehouse centre and the sorting centre.

16. The non-transitory computer-readable storage medium of claim 15, further comprises:
identifying one or more vehicles available for transporting the one or more products from the source location to the destination location, wherein the one or more vehicles are self-driven trucks; and
transmitting one or more messages indicating the generated transportation sorting plan and the sorting slots to the identified one or more vehicles for transporting the one or more products from the source location to the destination location.

17. The non-transitory computer-readable storage medium of claim 15, wherein determining the demand forecast corresponding to the one or more products based on the received request comprises:
estimating quantity of each of the one or more products required by the customer;
determining weight and volume of each of the one or more products based on predefined information; and
calculating total volume and total weight corresponding to each of the one or more products based on the estimated quantity and determined weight.

18. The non-transitory computer-readable storage medium of claim 15, further comprises:
validating if the number of sorting slots are less than the types of one or more products by comparing the number of sorting slots with the types of one or more products; and
generating a notification for instructing the authorized personnel to perform multi-batch sorting upon validating that the number of sorting slots are less than the types of one or more products, wherein the generated notification is outputted on the graphical user interface of the one or more electronic devices associated with the authorized personnel.

19. The non-transitory computer-readable storage medium of claim 15, further comprises optimizing the demand forecast based on the request received from the customer, wherein the demand forecast is optimized by one of:
updating the demand forecast based on the received request, wherein the demand forecast is updated by modifying the estimated quantity of the one or more products based on the received request comprising the types of the one or more products and the quantity of each of the one or more products; and
generating a notification for instructing the authorized personnel to load a set of products corresponding to the received request in a desired trailer for transporting the set of products from the source location to the destination location, wherein the generated notification is outputted on the graphical user interface of the one or more electronic devices associated with the authorized personnel.

20. The non-transitory computer-readable storage medium of claim 15, wherein the source location is the warehouse centre and the destination location is sorting centre.
